(19) United States
(12) Patent Application Publication
(10) Pub. No.: US 2023/0401598 A1
(43) Pub. Date: Dec. 14, 2023

(54) SYSTEM AND METHODS FOR PRODUCT DISTRIBUTION

(71) Applicant: GREAT SOFTWARE, LLC, Mount Pleasant, SC (US)

(72) Inventor: Christopher ROBERTS, Mount Pleasant, SC (US)

(21) Appl. No.: 18/210,039

(22) Filed: Jun. 14, 2023

Related U.S. Application Data
(60) Provisional application No. 63/352,179, filed on Jun. 14, 2022.

(51) Int. Cl. G06Q 30/0207; G06Q 30/0273; G06Q 30/0251; G06Q 30/0235

(52) U.S. Cl. CPC G06Q 30/0223; G06Q 30/0273; G06Q 30/0259; G06Q 30/0235

(57) ABSTRACT

A method of product distribution comprising using at least one hardware processor to: generating a plurality of venue offers including at least one or more brands of alcohol; obtaining a selection of a venue offer from the plurality of venue offers; and based on the selection, activating one or more customer offers corresponding to the one of the plurality of venue offers.

### TECHNICAL FIELD

The embodiments described herein are generally directed to product distribution, and, more particularly, to a system and method for an effective distribution of beverages between suppliers, retailers, and consumers.

### BACKGROUND

Alcoholic beverage manufacturers/suppliers and distributors rely on retailers (e.g., liquor, grocery, wine, convenience stores) and venues (e.g., bars, restaurants, sports facilities, music venues) to provide their products to consumers. The retailers/venues have to buy a product from a supplier and then turn around and sell the product to their customers. The retailer/venue has to pay upfront and take on a certain amount of risk that the product will not sell. Thus, retailers/venues may be reluctant to buy new, unknown, or non-typical beverages from suppliers/distributors. Suppliers normally have to employ sales representatives that pitch products to individual retailers/venues (e.g., a door-to-door approach). However, this marketing approach is costly to the supplier/distributor and often not efficient. For the retailers/venues, even with incentives (e.g., discounts or free samples), the risk of taking on new inventory remains, with no guarantees that customers will buy the inventory.

In addition, the distribution of product (e.g., during a marketing campaign) between manufacturers, distributor, retailers, venues, and consumers includes many different transactions (orders, payments, etc.) that are tracked within different systems, by different entities, such that analyzing and improving the distribution ecosystem becomes highly difficult.

The present disclosure is directed toward overcoming one or more of the problems discovered by the inventors.

### SUMMARY

In an embodiment, a method of product distribution is disclosed. The method comprising using at least one hardware processor to: generating a plurality of venue offers including at least one or more brands of alcohol; obtaining a selection of a venue offer from the plurality of venue offers; and based on the selection, activating one or more customer offers corresponding to the one of the plurality of venue offers.

In one embodiment, a system for product distribution and analysis is disclosed. The system comprising: a plurality of mobile user device including user interfaces; at least one hardware processor in communication with the plurality of mobile user devices; and one or more software modules configured to, when executed by the at least one hardware processor: identify a location of each of the plurality of mobile user devices; determine that a user of a first user device of the plurality of mobile user devices meets one or more offer redemption conditions; display a plurality of consumer offers based on the location of the first user device; receive a selection of one consumer offer of the plurality of consumer offers; and enable a user of the first user device to redeem the one consumer offer at a venue.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3A illustrates a process of a product distribution and market research platform engaging with a venue, according to an embodiment;

FIG. 3B illustrates a funds and product flow diagram illustrating part of the process of FIG. 3A;

FIG. 3C illustrates a process of a product distribution and market research platform engaging with a venue with respect to existing inventory, according to an embodiment;

4A-4G illustrate a user interface screen during the process of product distribution of FIG. 3A; and

FIGS. 5 and 6A-6G illustrate a process of a product distribution and market research platform engaging with a consumer, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

In an embodiment, systems and methods are disclosed for a platform that facilitates a more efficient and effective alcoholic beverage distribution, as well as data collection and analysis of the alcoholic beverage distribution. Although the examples of the disclosure are described with respect to alcoholic beverage distribution, various processes, systems, and functions of the disclosure may be applied to other types of products (e.g., non-alcoholic beverages, food, snacks, etc.).

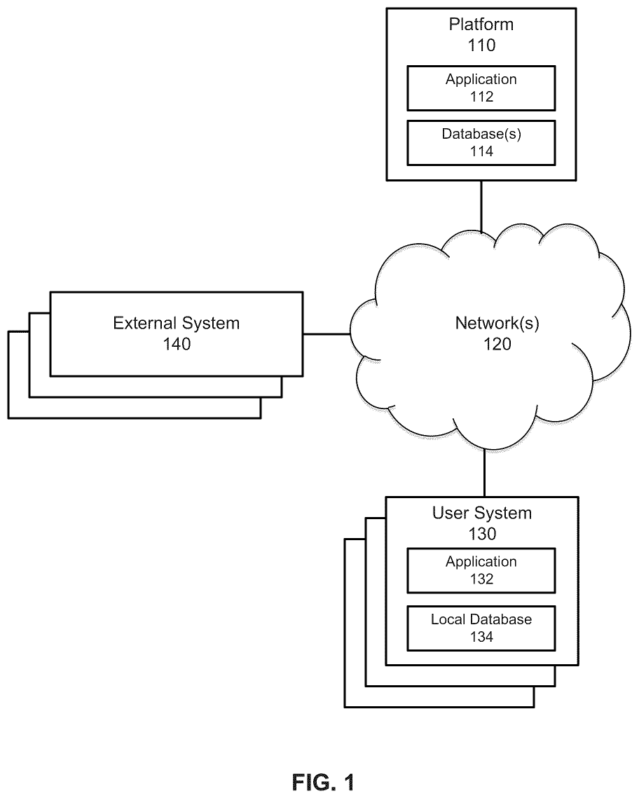

FIG. 1 illustrates an example infrastructure in which one or more of the disclosed processes may be implemented, according to an embodiment. The infrastructure may comprise a product distribution and market research platform 110, e.g., one or more servers, which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to one or more server applications 112 and/or one or more databases 114. The server applications 112 include additional applications, some of which originate with external parties, and which have been integrated into platform 110 and made available via one or more application programming interface (API). In addition, platform 110 may be communicatively connected to one or more user systems 130 via one or more networks 120. Platform 110 may also be communicatively connected to one or more external systems 140, e.g., other platforms, websites, etc., via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134. Additionally, a user system 130 might also rely on an application or database external to the user which will be connected to the user system and/or external system via an application programming interface (API).

Platform 110 may comprise web servers which host one or more websites and/or web services. In embodiments in which a website is provided, the website may comprise a graphical user interface, including, for example, one or more screens, e.g., webpages, generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols, e.g., HTTP, HTTPS, etc. These screens, e.g., webpages, may comprise a combination of content and elements, such as text, images, videos, animations, references, e.g., hyperlinks), frames, inputs, e.g., textboxes, text areas, checkboxes, radio buttons, drop-down menus, buttons, forms, etc., scripts, e.g., JavaScript, and the like, including elements comprising or derived from data stored in one or more databases, e.g., database(s) 114, that are locally and/or remotely accessible to platform 110. Platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data, e.g., user data, form data, etc., to be stored in database(s) 114, and/or request access to data stored in database(s) 114. Any suitable database may be utilized, including without limitation My SQL™, Oracle™, IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module, e.g., comprised in server application 112, executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein. In an embodiment, client application 132 may utilize a local database 134 for storing data locally on user system 130.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110, e.g., in which case server application 112 performs all processing, or user system(s) 130, e.g., in which case client application 132 performs all processing, or be distributed between platform 110 and user system(s) 130, e.g., in which case server application 112 and client application 132 both perform processing, or can comprise one or more executable software modules comprising instructions that implement one or more of the processes, methods, or functions described herein.

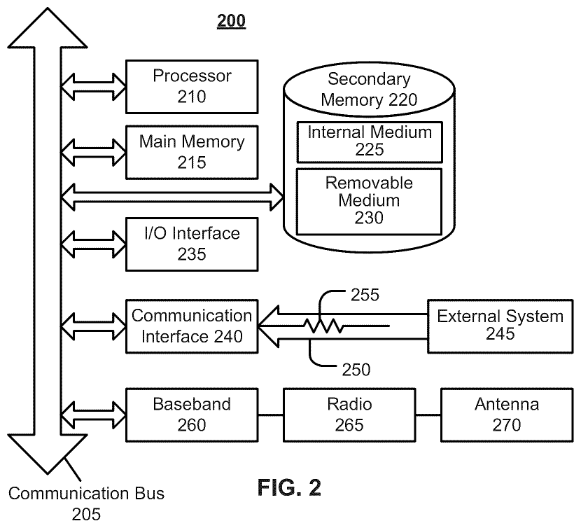

FIG. 2 is a block diagram illustrating an example wired or wireless system 200 that may be used in connection with various embodiments described herein. For example, system 200 may be used as or in conjunction with one or more of the functions, processes, or methods, e.g., to store and/or execute the software, described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms, e.g., digital-signal processor, a slave processor subordinate to the main processing system, e.g., back-end processor, an additional microprocessor or controller for dual or multiple processor systems, and/or a coprocessor. Such auxiliary processors may be discrete processors or may be integrated with processor 210. Examples of processors which may be used with system 200 include, without limitation, any of the processors, e.g., Pentium™, Core i7™, Xeon™, etc., available from Intel Corporation of Santa Clara, California, any of the processors available from Advanced Micro Devices, Incorporated (AMD) of Santa Clara, California, any of the processors, e.g., A series, M series, etc., available from Apple Inc. of Cupertino, any of the processors, e.g., Exynos™, available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code, e.g., any of the software disclosed herein, and/or other data stored thereon. The computer software or data stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 include an external hard disk drive, an external optical drive, an external magneto-optical drive, and/or the like.

As mentioned above, system 200 may include a communication interface 240. Communication interface 240 allows software and data to be transferred between system 200 and external devices, e.g. printers, networks, or other information sources. For example, computer software or executable code may be transferred to system 200 from a network server, e.g., platform 110, via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network, e.g., network(s) 120, or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network, e.g., network(s) 120, or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code, e.g., computer programs, such as the disclosed software, is stored in main memory 215 and/or secondary memory 220. Computer-executable code can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225 and/or removable medium 230), external storage medium 245, and any peripheral device communicatively coupled with communication interface 240 (including a network information server or other network device). These non-transitory computer-readable media are means for providing software and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display, e.g., in a smartphone, tablet, or other mobile device.

System 200 may also include optional wireless communication components that facilitate wireless communication over a voice network and/or a data network, e.g., in the case of user system 130. The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions, i.e., computer programs, such as the disclosed software) that can be stored in main memory 215 or secondary memory 220. Computer programs can also be received from baseband processor 260 and stored in main memory 210 or in secondary memory 220, or executed upon receipt. Such computer programs, when executed, can enable system 200 to perform the various functions of the disclosed embodiments.

Embodiments of processes for product distribution will now be described in detail. It should be understood that the described processes may be embodied in one or more software modules that are executed by one or more hardware processors, e.g., processor 210), for example, as a software application, e.g., server application 112, client application 132, and/or a distributed application comprising both server application 112 and client application 132, which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component, e.g., general-purpose processor, integrated circuit (IC), application-specific integrated circuit (ASIC), digital signal processor (DSP), field-programmable gate array (FPGA) or other programmable logic device, discrete gate or transistor logic, etc., combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

As will be described further below, the product (e.g., alcohol) distribution platform 110 allows manufacturers, suppliers, distributors, and retailers to make products available to venues (e.g., bars and restaurants) along with a flow of customers who will come into the venue and try the product. For the purposes of this disclosure, manufacturers, suppliers, distributors, retailers, and combinations thereof will be grouped under “provider” of product for venues (e.g., entities that can provide alcoholic beverages to a venue). On the other hand, customers/consumers using the platform may be directed to local venues to try drinks/cocktails that are actually (partially or fully) paid for by someone other than the customer.

Beverage providers may use the platform 110 to create a marketing campaign for one or more of the products that they want to promote. A campaign may include one or more of: brand(s) of alcohol, recipes that incorporate those brands, a number/amount (e.g., number of bottles) of liquor available for the campaign, macro target geolocations, target consumption numbers, budget or fees for distribution, and cost per consumption. For example, a beverage provider may want to promote a new brand of alcohol by making sure a specific number of bottles are actually consumed by customers within a certain geolocation. The beverage provider may set the preferred number of different venues for participating in the campaign, specific types of venues, preferable locations of the venues, the number of bottles per venue offer (optionally, depending on type/specifics of the venue), etc. The beverage provider (e.g., the supplier, distributor, wholesaler, retailer, etc.) may also set a budget or fee for the distribution of the brand of alcohol during the marketing campaign, a timeframe for the marketing campaign (e.g., number of months), preferred times of operation (e.g., specific months, specific days of the week, specific holidays), and other preferred targets/parameters The beverage provider may also provide one or more drink/cocktail recipes that use the new brand of alcohol. In some embodiments, a campaign may include one or more primary targets or parameters (e.g., number of different consumers who will try the beverage, number of different venues, etc.) as well as one or more secondary targets or parameters (e.g., total number of bottles consumed, etc.). The order/preferences of the targets/parameters may be set for the campaign by the beverage provider. In one embodiment, the platform 110 provides a number of default parameters that may be changed/customized by the beverage provider. In one embodiment, the beverage provider may also include the information that should be collected or analyzed by the platform 110 during the marketing campaign. In one embodiment, the platform 110 includes data collection/analysis functionality that accumulates and analyzes data of the campaign, and optionally, other campaigns.

Once a beverage provider has signed up for a campaign to promote a particular alcoholic beverage and provided the appropriate information (e.g., targets, parameters) to the platform 110, the platform 110 may generate or help generate one or more promotional offers to both venues and consumers, based on the parameters of the marketing campaign. For example, the platform 110 may generate an offer for the campaign for venues that includes a recipe or recipes using the alcoholic beverage, number of bottles within an offer, and one or more incentives. In one embodiment, the platform 110 may obtain or generate its own recipes (for example, if none are specified by the beverage provider). At the same time, the platform 110 may generate a number of offers to customers based on the venue offer, each one which would go live/be published as soon as a venue manager makes it available (activates the offer).

The venues and consumers can then participate in the campaign by selecting offers available via the platform 110. In one embodiment, different applications and user interfaces connected to the platform 110 are made available for venues, customers, and beverage providers. In one embodiment, different function tiers or versions of the platform 110 may be made available to consumers, for example, a first free tier with a limited number of offers (e.g., per month, per day, etc.), a second paid tier/version that would unlock more drinks, better offers, better types of alcohol, etc.

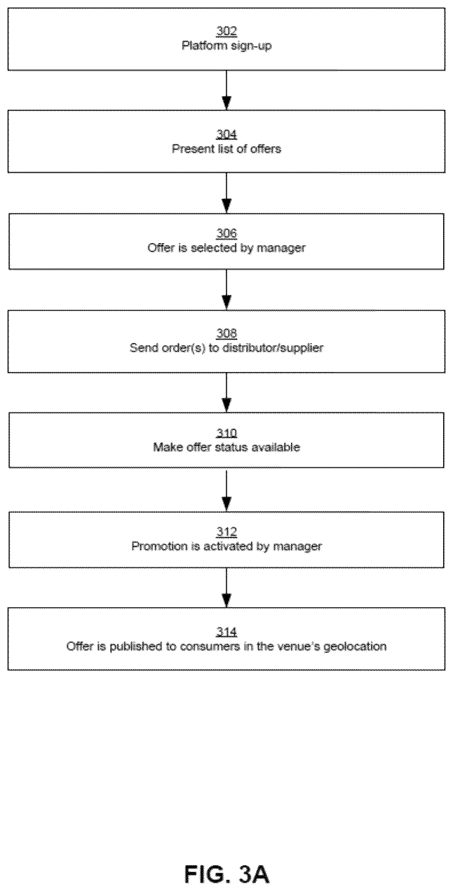

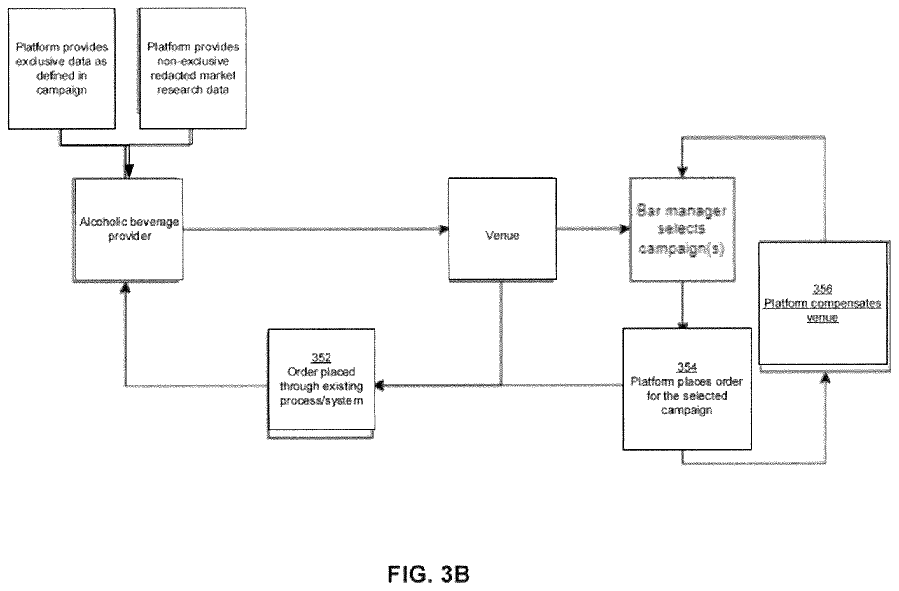

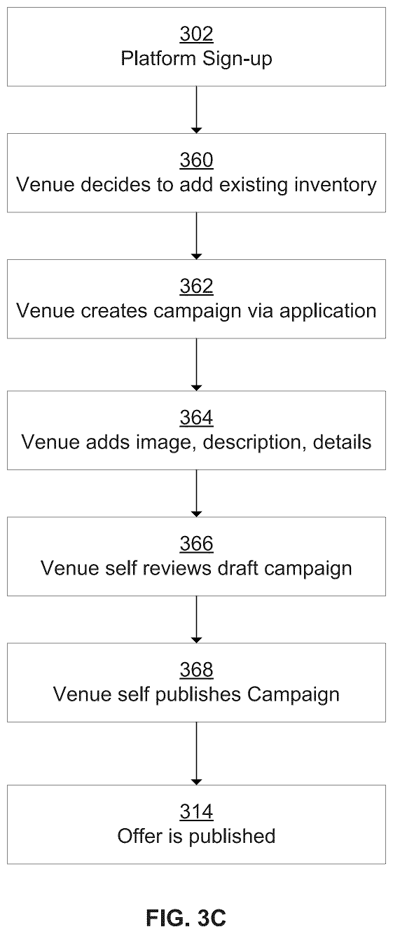

FIG. 3A is a flow chart illustrating a process of using the platform from the viewpoint of a venue manager (or a retailer manager/authorized person). FIGS. 4A-4G illustrate application screen shots that may be shown to the venue manager during the process of FIG. 3A.

In step 302, the venue manager signs up for the platform 110 via, for example, a user system 130. This may include: downloading a software application/app of the platform to a user device or accessing the platform form a URL address using an internet browser on a user device; signing up to use the platform using normal means (e.g., email, username, password, verification, etc.); and getting trained on using/operating the platform. In one embodiment, the software application downloaded onto the user device may obtain geolocation information of the venue. Alternatively or additionally, the venue manager may provide/input the venue location information and, optionally, other venue information to the platform 110 via the user system 130. In one embodiment, the manager may provide features of the venue to the platform 110, for example, size of the venue, type of venue (sports bar, night club, high-end restaurant, etc.), operating hours, type of neighborhood (e.g., walkability score), typical clientele (e.g., college students or families), type of food served, etc. Alternatively or additionally, the platform 110 may obtain some or all of the additional features of the venue from third-party/external sources (e.g., review sites). In one embodiment, the manager may also include certain product offer preferences (including type of alcohol, amount, etc.).

In addition, the sign up process may include the venue manager providing to the platform 110 information needed to order product on behalf of the venue. This may include providing information of a normal (non-campaign, non-platform) ordering channels to the platform including, for example, order placement emails, financial information (e.g., venue credit card or banking information), specific beverage provider ordering systems (e.g., website, app), specific ordering forms, etc. This step ensures that the platform 110 can correctly place orders for product on behalf of the venue.

The software application and/or URL may include a user interface specific to venue managers/personnel. The platform training for the venue manager may be provided by the application/platform via one or more of instructional video, audio, reading material, or access to in-person training. A “venue manager” in this disclosure may be any person who is authorized to purchase inventory for a venue (e.g., bar or restaurant).

In step 304, the platform 110 presents a list of promotional campaign offers to the venue manager using the venue user interface of a user system 130. The list of offers may be based on one or more of: the geolocation of the venue (obtained in step 302), one or more features of the venue, and preferences of the venue manager. For example, campaign offers by beverage provider within a certain mile radius may be provided. In another example, the platform 110 may generate offers including more beer products for a sports bar type venue. FIG. 4A is an example of a venue user interface (e.g., of a user system 130) showing a list of promotional offers/campaigns. Each of the campaign offers may include one, all, or a combination of: the type/brand of product/alcoholic beverage that will need to be obtained by the venue within the campaign offer, information about the type/brand of product/alcoholic beverage (e.g., category, alcohol concentration, origin, etc.), a recipe for the drink/cocktail that uses the product/alcoholic beverage, image(s) of the drink/cocktail, additional information about the drink/cocktail, amount of product/alcoholic beverage (e.g., number of bottles) in the offer, an incentive/compensation offered to the venue by the campaign (e.g., monetary compensation/reward, foot traffic, awareness/attention to venue, etc.) for participating in the market research activities, the number of offers (of this specific kind) still available within the campaign, and information about the beverage supplier (e.g., initiator of the campaign). The additional foot traffic and/or attention to the venue may include at least at target number of customers that the platform 110 will potentially guide to the venue using the campaign (e.g., specifically to try this recipe). FIG. 4B shows a summary of an individual offer, which may be rejected or accepted by the venue manager.

In step 306, an offer is selected by the manager by, for example, pressing “accept” and confirming the selection. FIG. 4C shows an example of a screen for confirming an order.

In step 308, after the venue manager has confirmed the order, the order is sent to the beverage provider by the platform. FIG. 4D shows an example of a screen showing to the manager that the order has been sent. FIG. 3B shows a diagram of the ordering process of step 308. In one embodiment, as shown in FIG. 3B, the platform 110 places the offer 354 via normal operation ordering channels 352, for example, an email from the platform 110 with the order is sent to the appropriate email of the beverage provider while the appropriate venue personnel (e.g., the venue manager, venue accounting, etc.) is copied on the email. In one embodiment, the order may include a reference to the specific campaign as well as the type/amount of alcohol, address of delivery, payment information, etc.

In an embodiment, the step 308 triggers a payment/compensation 356 from the platform 110 to the venue for participating in the marketing campaign (e.g., providing their facilities, staff/labor, etc.) and offering drinks to customers for no cost (or at reduced cost). In one embodiment, the monetary compensation 356 may be pre-agreed upon by the beverage provider as part of the distribution stipend/budget of the offer within the campaign. In another embodiment, the compensation to the venue is determined by the platform 110 based on one or more of: type of facility of the venue (e.g., sit-down restaurant, sports bar, etc.), size of the venue, capacity of the venue, neighborhood/location of the venue, types of licenses the venue holds, days/hours the venue is open, types of clientele, typical number of patrons, skill of the staff/workforce at the venue, skill required to participate in the chosen campaign (e.g., difficulty of the recipe(s)), etc. In one embodiment, the compensation that is shown to the venue manager viewing the offer may change depending on one or more of the above parameters.

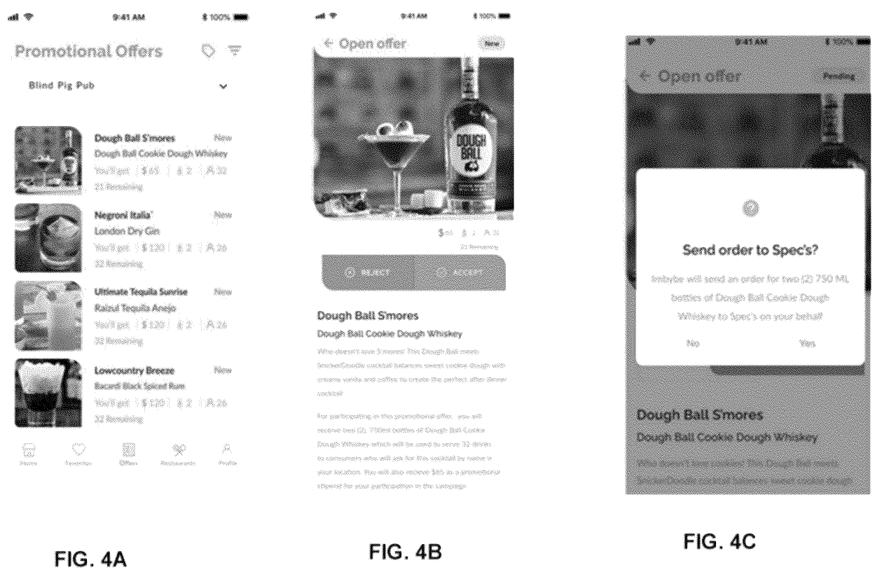

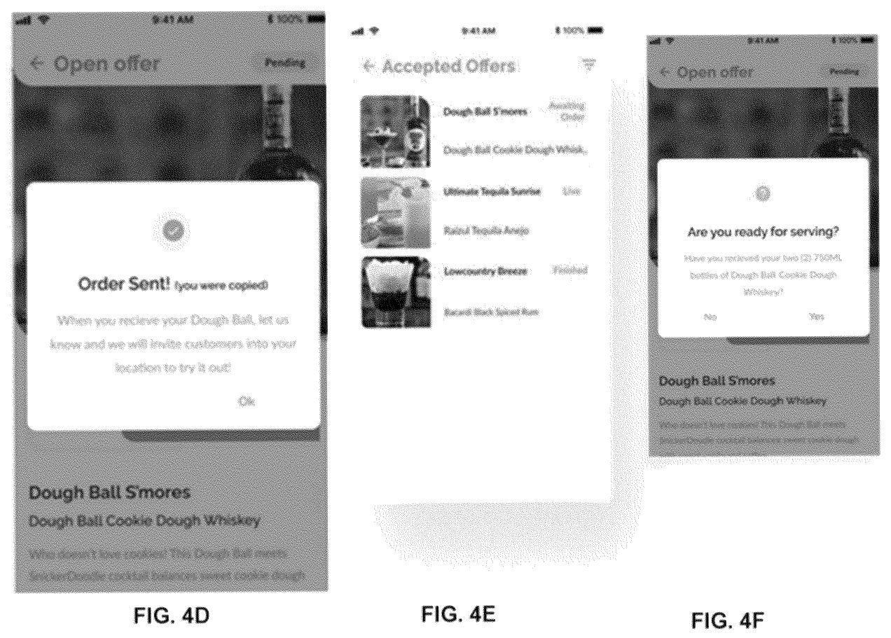

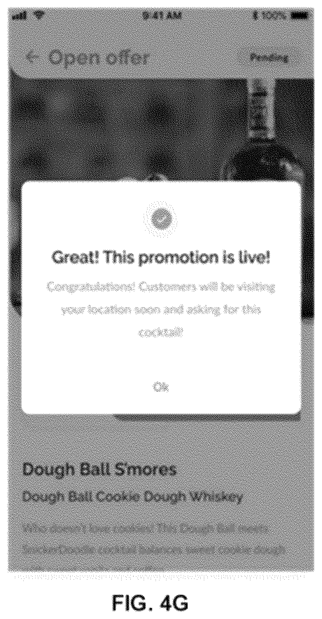

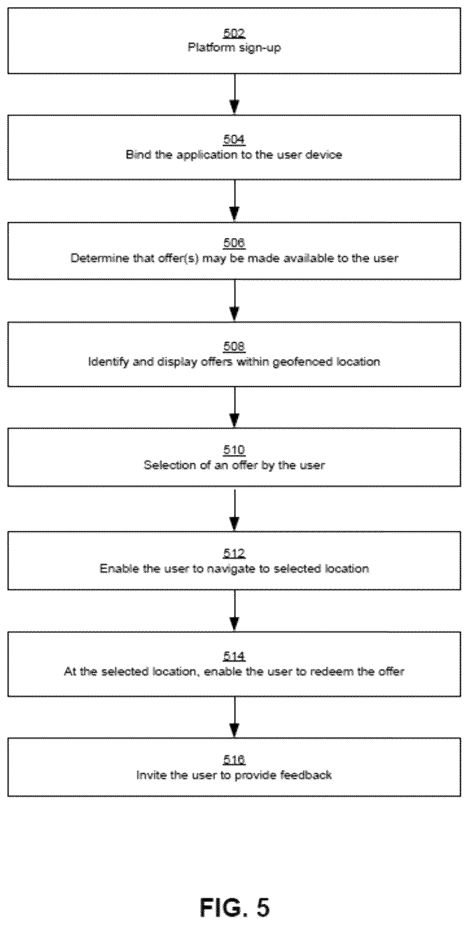

In one embodiment, the compensation 356 to the venue at least partially depends on the total number of corresponding drinks that will be served to customers by the venue within the campaign. This total number of drinks may be set by the platform 110 as the number of customer offers published to customers (described further in FIG. 5).

Note that the compensation 356 to the venue from the platform may offset some or all of the cost/risk that the bar/venue manager takes when buying products that may be unknown, or out of the norm for the venue. In addition, the venue gains a guaranteed stream of customers that, in participating in the campaign, will come to the venue to try the specific drink/recipe associated with the campaign.

In addition to sending the order to the beverage provider and compensating the venue, step 308 also removes a single count of the selected campaign from the available campaign venue offers within the platform 110 system, so that the number of available promotional offers to venues is accurately reflected for other venue managers looking for promotional offers. For example, if a Dough Ball S'mores offer has been selected and confirmed by a manager after viewing the list of promotional offers shown in FIG. 4A, the count of Dough Ball S'mores offers would change from 21 to 20 remaining offers.

As shown in step 310, after the order has been sent, the application can be used to view the status of the order, for example, as shown in FIG. 4E, and anticipate delivery/fulfillment of the order.

After the offer is fulfilled by the beverage provider (i.e., the product is delivered to the venue), the offer promotion to customers is activated by the manager in step 312 (FIG. 4F). This step may also include, before activating the promotion, providing training to the staff of the venue, including, training to make the drink/cocktail using the recipe of the promotional offer.

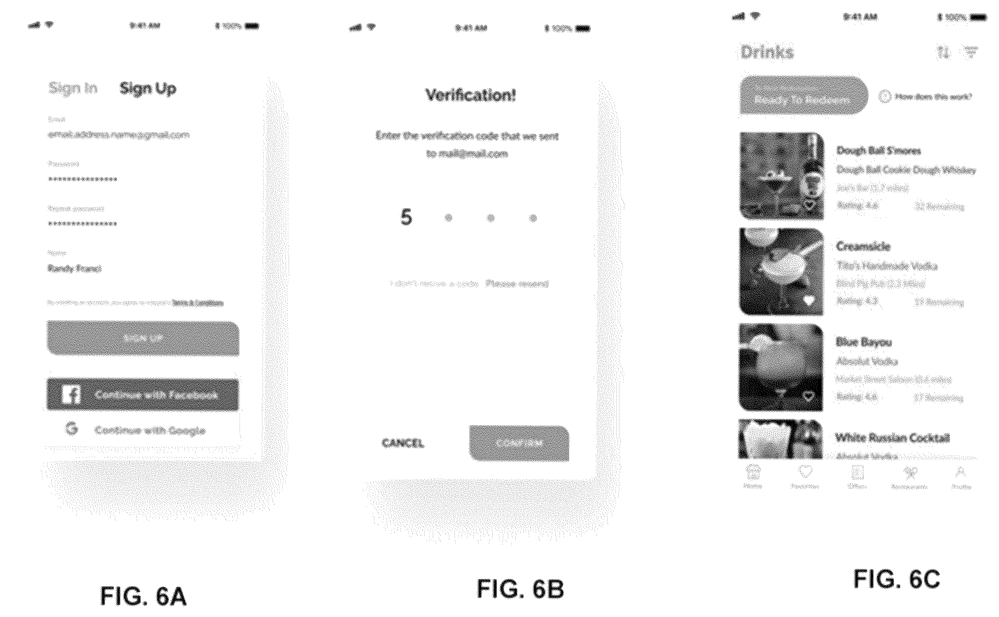

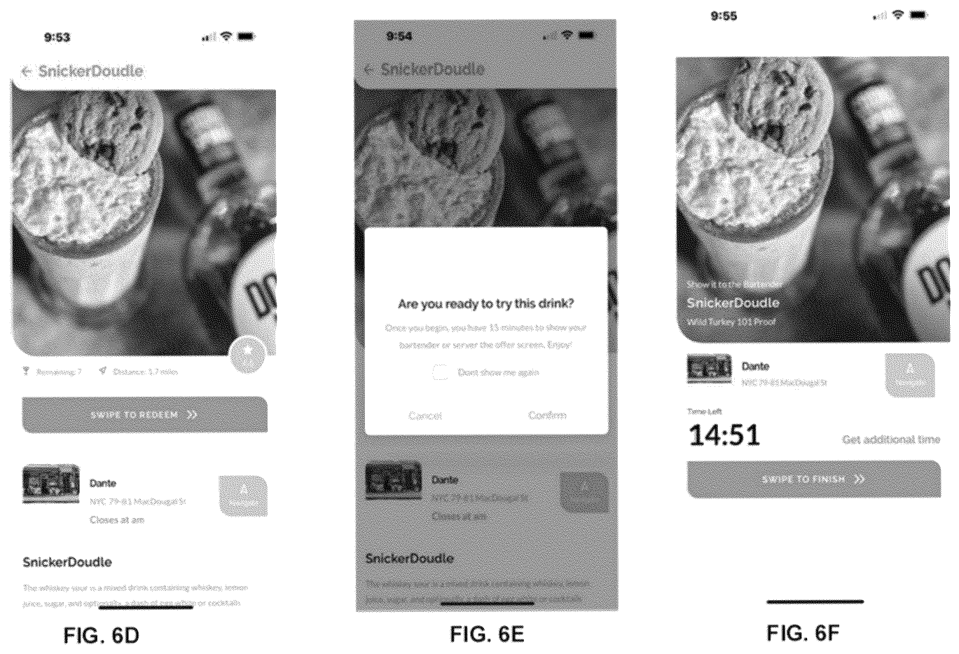

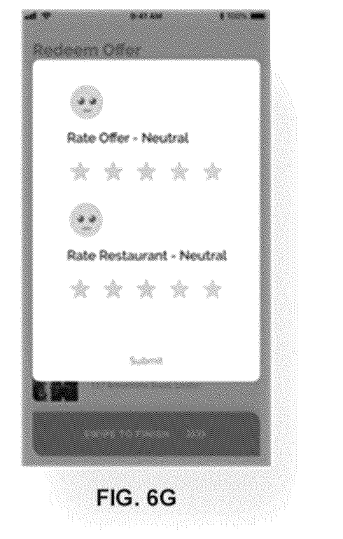

In step 314, in response to activation of the promotion to customers (step 312), the offer/promotion is published to consumers by the platform 110 and is considered live (FIG. 4G). The number of available redemptions of the customer offer at the venue may be set by the campaign and may correspond to the target or expected number of potential customers that the platform 110 could draw or attract in the campaign (e.g., 32 customers for Dough Ball S'mores in FIG. 4A). In one embodiment, the promotion is published based on the venue's geolocation, such as to all consumers within a defined radius (e.g., a mile, five miles, 15 miles, etc.) that may be set by the platform, or a driving or walking (or other means of transportation) distance and/or duration. Alternatively, or additionally, the promotion may be published based on user demographics, preferences, or additional user data (e.g., taste profile). The offer promotion may be published to user systems 130 of potential customers/consumer who have signed up for the platform 110 as consumers. The consumer-side interface is further described below with respect to FIGS. 5 and 6A-6G.

While the process of FIG. 3A is illustrated with a certain arrangement and ordering of subprocesses, the process may be implemented with fewer, more, or different subprocesses and a different arrangement and/or ordering of subprocesses. It should be understood that any subprocess, which does not depend on the completion of another subprocess, may be executed before, after, or in parallel with that other independent subprocess, even if the subprocesses are described or illustrated in a particular order.

Once the venue manager signs up, e.g., as described with respect to step 302, the venue manager can also use platform 110 to create campaigns involving existing inventory as illustrated in the flow chart of FIG. 3C. Thus, once the venue is signed up (step 302), the, e.g., venue manage can decide to add existing inventory to a campaign in step 360. For example, if the venue has inventory that is not moving, or if they want to clear it out to make room for new inventory for any reason, they can create a campaign around or and the existing inventory to a campaign.

In step 362, the venue manager, or other administrator associated with the venue can then add images, description, and other details such as quantity, term, availability, etc., review the draft campaign in step 364, and then publish the campaign is step 366.

FIG. 5 is a flow diagram of a process of using the platform 110 from a consumer side. FIGS. 6A-6G illustrate examples of screenshots of a consumer user device when using a software application of the platform 110.

In step 502, the consumer/user signs up for the platform 110 via a user system 130. This may be done by, for example, downloading a software application 132 onto a mobile user device/system 130 and then signing up using customary sign-up steps (e.g., providing email, password, verification, agreeing to terms and conditions, etc.) as shown in FIG. 6A-6B. The sign-up step may additionally require or ask the user to provide user demographic details, user alcohol consumption preferences, ask other types of questionnaires, and verify that the user is over the drinking age in their legal jurisdiction.

In step 504, the application 132 is bound to the mobile user device, for example, by binding to the universally unique identifier (UUID) of the user device. This ensures that the application can control the number of promotion redemptions available to the user per time period (e.g., per month, per day) and a user would not be able to take advantage of additional offers by using, for example, multiple emails. Step 504 also includes asking the user to activate location tracking, to ensure that any promotional offers are appropriately geofenced in order to provide a good user experience. In other embodiments, other mechanisms, such as two-factor authentication can be used to authenticate the user and control redemptions.

In step 506, the platform 110 (or the application 132 connected with the platform 110) makes a determination of the offers that can be made available to the user at this time. This may require the platform 110 to determine whether one or more conditions have been met. In one embodiment, the determination requires the platform to determine: whether the user is within an allotted number of redeemable offers per month (e.g., that a threshold number of redeemed offers per month has not already been exhausted) and whether the user is with an allotted number of redeemable offers per day (e.g., only one offer per day may be redeemed). If the conditions have not been satisfied (e.g., the user has already used up their allotted number of offers that month), the user interface can notify the user that no offers can be made available at this time.

In an alternate embodiment, the platform 110 may, at this point, make more offers available for a fee. In another embodiment, the user may sign up for a paid version/tier of the platform services that may increase the number or quality of the offers.

If the conditions have been satisfied, in step 508, the platform 110 searches its database(s) and identifies the promotional offers that may be available to the user using the user device geolocation. The offers are those that have been published by one or more venues (as described in FIG. 3A) within, for example, a certain radius of the user location. In one embodiment, the offers shown to the user are further customized by the platform using, for example, user demographics, time of day, usual location (e.g., not current location, but frequently visited areas), usual types of venues, user preferences (e.g., submitted by the user or gathered analytically by the platform 110), user flavor profile(s) (e.g., determined by the platform), etc.

Once the offers have been identified, they may be displayed as a list or graph to the user via the application 132 user interface (FIG. 6C). Each of the promotional offers available to the user may include, for example, image(s) and description of the drink/cocktail, the venue at which the drink is available, the distance to the venue, the number of remaining drinks (using the promotion) at that venue, and the rating of the drink from other customers.

In step 510, the customer/user selects an offer from the offers identified and displayed in step 508. As shown in FIG. 6D, the user interface of the application 132 provides a way for the user to select/redeem an offer, for example, by swiping on the offer.

In step 512, in response to receiving the selection of the offer, the application may enable the user to navigate to the venue of the offer, for example, by enabling the user to switch to a navigation program/app (e.g., Waze, maps). The address of the venue may be automatically inputted into the navigation program by the platform 110 or user device application 132. The application may then monitor the location of the user device 130 to determine when the user arrives at the venue.

At step 514, once the application has determined that the user is at the correct location, the user may choose to redeem the offer (FIG. 6E) of the drink/cocktail. In response, staff of the venue may accept the presented offer and fulfill it (e.g., serve the drink/cocktail to the customer).

Once the user/customer confirms on the app that they are ready to redeem their offer, a countdown may begin (e.g., 15 minutes) for the drink/cocktail to be obtained. This countdown may be reflected on the user interface of the application as a “time left” number countdown (shown in FIG. 6F), as a graphical or number countdown (e.g., a moving bar), or both. Additionally or alternatively, the screen presents an animated (e.g., scrolling) component/graphic.

The user may show the offer screen, including the moving/changing timer and/or additional animated component, to a staff member (e.g., server) in order to redeem the offer. Note that this would not require the server to scan any type of barcode, but to simply visually verify that the offer is presented live (including changing timer, animated or moving component, etc.) on the user device application. Since the offer was posted by the venue, the staff would be trained on the procedure. The changing timer and/or animated component, and possibly other information such as current date and time stamp, venue location, etc., ensures that the offer is genuine and not counterfeit (e.g., a screen capture). In one embodiment, the application also includes a built-in feature that prevents a user from capturing any page within the application.

Once the server fulfills the order, the customer can let the application know that the order is done by, for example, pressing or swiping a “finish” button within the application.

Redeeming/accepting the offer (customer showing the screen to a server and server making/providing the drink/cocktail to the customer) does not require the user/customer to perform any sort of monetary transaction, since the drink offer is part of the marketing campaign. Thus, the customer would not need to get out a wallet or even activate an electronic (e.g., wireless) form of payment. This may greatly reduce the time/effort required of a customer to get a drink, which may additionally incentivize the customer to try this particular (marketing campaign) drink.

In response to the customer indicating that the offer has been redeemed/accepted in step 514, the platform 110 or application 132 may, in step 516, invite the user to provide their feedback. For example, the user can, via the app, rate their experience at the venue as well as the drink/cocktail (FIG. 6G). Although FIG. 6G shows two simple star ratings, different/more complicated rating systems are within the scope of the disclosure. For example, the user may be asked to rate features of the venue (e.g., atmosphere, service, etc.) and features of the drink (e.g., amount of alcohol, taste combination, presentation, etc.). In one embodiment, the platform 110 may change the type of feedback it requires based on, for example, particular marketing campaign parameters, an amount of time the customer has used the platform, the type of questions the user has answered before, a type/category of drink, etc.

A notification/reminder to provide the rating may be sent to the user, for example, a predetermined time after the offer is redeemed or once the application has determined that the user has left the venue or arrived home.

In one embodiment, the platform 110 offers incentives to the user to rate their experience. In another embodiment, the platform 110 blocks the user from accessing further offers if the previous redeemed offer has not been rated by the user. In another embodiment, the platform 110 may give a user a time period (e.g., a week) after an offer has been redeemed to provide the feedback before blocking further offers.

In addition, the platform 110 may collect additional data from each user in small chunks by, for example, dribbling questions/inquiries to the user in small amounts. For example, ten questions of a questionnaire may be distributed over feedback for ten different offer redemptions. Over time, a more and more complete profile of the user may be collected by the platform 110 using the feedback.

In addition, the platform 110 may supplement the profile data using passive information gathering, for example, determining the types of venues a user statistically visits most often, the times of day (and/or day of the week) a user is more likely to redeem a drink, the types of drink that a user chooses most often (e.g., beer-based, wine-based, sweet/bitter/sour/etc. drinks), the locations most frequently visited by the user, etc.

The actively collected data (e.g., using user feedback) and the passively collected data (e.g., based on user decisions/actions) may be combined with demographic data of the user, and any other data collected by the platform 110. In one embodiment, the platform 110 may analyze (e.g., using machine learning algorithms) data of each user to generate, for example, a user flavor profile. In one embodiment, the platform 110 may create multiple flavor profiles for each user (e.g., a beer profile, a wine profile, etc.) as well as a combined master flavor profile.

In one embodiment, the platform 110 may use data from multiple users to analyze consumer behavior with respect to one or more parameters. For example, the platform may analyze all users within a specific geographic location (e.g., a zip code, a neighborhood). In another example, the platform may analyze all users with similar flavor profiles in order to find commonalities. In another example, the platform may analyze user data to determine that customers who like a first specific drink would also like a second specific drink. In one example, machine learning may be used to detect patterns within the user data, e.g., grouping similar users.

In one embodiment, the platform 110 may also develop profiles of alcoholic beverages based on the user data as well as additional data (e.g., provided by the beverage manufacturer and/or collected from external sources). Additional data may include, for example, type of hops, type of grape, brewing/fermentation conditions, etc. In one example, if a beverage is used in multiple recipes, the platform may use the feedback of users to those recipes to determine optimal flavor combinations using that specific beverage (e.g., a specific liquor may be most popular with a sweet or bitter flavor addition, or a more complex combination of flavors). The platform may also group or categorize alcoholic beverages based on the user data and the additional data. For example, machine learning algorithms may be used to find unexpected groupings of spirits that may be popular with a group of users.

In one embodiment, the platform 110 may also develop profiles for venues using the user data as described above, as well as the venue-provided data. For example, the platform may determine specific characteristics (and combinations thereof) of customers that match characteristics (and combinations thereof) of a venue. For example, customers from a particular demographic and a particular beer profile may be determined to patronize venues with certain characteristics (e.g., light/dark atmosphere, type of music, location, neighborhood, etc.).

In one embodiment, the platform 110 may collect and analyze one or more of the user, venue, and beverage data, and provide the collected data and/or the analyses to alcohol suppliers/manufacturers/etc. In one embodiment, a beverage provider that creates a marketing campaign via the platform 110 may, within the terms of the campaign or in addition to the campaign, request one or more types of data gathered from the campaign. In another embodiment, the beverage provider may request additional data that was collected by the platform 110 outside of the current campaign. For example, a beverage provider may request all data pertaining to beer and beer-based drink consumption within a particular geographic area, including data from campaigns that were requested by other entities. In another embodiment, the platform 110 may offer to make certain data exclusive to the campaign-requesting beverage provider (e.g., at a higher cost, the campaign data would be available only to that beverage provider). FIG. 3B illustrates the two types of research data that may be provided to the alcohol beverage provider by the platform.

The product distribution platform 110 of the disclosure may be used by suppliers/distributors, by retailers/venues, and by customers/consumers via separate user interfaces connected to individual user systems, for example, a supplier/distributor interface, a retailer/venue interface, and a customer interface. In one embodiment, suppliers/manufacturers and distributors may also use separate user interfaces. However, the various data from the distribution ecosystem used by the platform 110 may be collected/aggregated by the platform 110 for storage and analysis, as discussed above.

In some embodiments, the platform 110 and customer application may be configured to later provide the customer/user a discount of the alcohol used in the drink/cocktail that the user has consumed. For example, if the user has rated the drink highly within the platform 110 after trying it at a bar, the platform 110 (e.g., via the user application) may generate a coupon/discount for the alcohol brand used in the drink at the user's local retail grocery/liquor store(s). In addition, this may trigger a transaction or suggestion to the supplier of that alcohol brand to move the liquor store(s). For example, if a high enough (threshold) number of customers within a certain geolocation of a liquor store have highly rated drinks/cocktails that use a certain liquor brand/product, the platform 110 may generate discounts for those users and trigger a movement of the liquor brand to the liquor store. This type of transaction and the triggers for the transaction may be pre-agreed upon by the liquor store and the supplier.

While the process of FIG. 5 is illustrated with a certain arrangement and ordering of subprocesses, the process may be implemented with fewer, more, or different subprocesses and a different arrangement and/or ordering of subprocesses. It should be understood that any subprocess, which does not depend on the completion of another subprocess, may be executed before, after, or in parallel with that other independent subprocess, even if the subprocesses are described or illustrated in a particular order.

In certain embodiments, the data an analysis described above can be used to provide more targeted marketing for a campaign. For example, if a venue is doing a campaign around bourbon, the data and analytics can be mined to identify strong targets in the surrounding area. The campaign can then be targeted to these individuals. In some embodiments, however, the campaign can also be opened to anyone who is in, or within a certain radius of the venue. This will avoid, e.g., the situation where someone is in the venue and has the app., but did not get the offer, whereas someone, e.g., right next to this individual, did get the offer.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of consumable product. Hence, although the present embodiments are, for convenience of explanation, depicted and described as being implemented for bars/restaurants with respect to alcoholic beverages, it will be appreciated that it can be implemented in various other types of retailers and consumable products.

What is claimed is:

1. A method of product distribution comprising using at least one hardware processor to:
generating a plurality of venue offers including at least one or more brands of alcohol;
obtaining a selection of a venue offer from the plurality of venue offers; and
based on the selection, activating one or more customer offers corresponding to the one of the plurality of venue offers.

2. The method of claim 1, wherein the plurality of venue offers further includes a recipe using the at least one or more brands of alcohol.

3. The method of claim 2, further comprising: based on the selection of the one of the plurality of venue offers, providing one or more training modules for making the recipe via a user interface.

4. The method of claim 1, wherein generating the venue offer is based on one or more campaign parameters.

5. The method of claim 4, wherein the one or more campaign parameters include the one or more brands of alcohol, recipes that incorporate the one or more brands of alcohol, an amount of the one or more brands of alcohol available for the campaign, macro target geolocations, target consumption numbers, a budget for distribution, and cost per consumption.

6. The method of claim 5, wherein the selection of the one or more venue offers triggers an automatic payment, wherein the automatic payment is based at least on the budget for distribution.

7. The method of claim 5, wherein the one or more customer offers is based at least on the macro target geolocation.

8. The method of claim 5, wherein the one or more customer offers includes a predetermined number of offer redemptions based at least one the target consumption numbers.

9. The method of claim 8, further comprising: receiving a selection of one of the one or more customer offers; and based on the selection of the one of the one or more customer offers, reduce the predetermined number of offer redemptions by one.

10. A system for distribution of alcoholic beverages comprising:
a product distribution platform;
a plurality of user interfaces connected to a plurality of user systems;
at least one hardware processor; and
one or more software modules configured to, when executed by the at least one hardware processor:
obtain product campaign parameters including geolocation information; generate a plurality of venue offers and customer offers, based on the product campaign parameters;
transmit the plurality of venue offers to one or more venues based on the geolocation information;
receive a selection of one of the venue offers by a venue manager of a first venue via a first of the plurality of user systems; and
based on the selection, automatically perform an order transaction and publish a corresponding customer offer of the plurality of customer offers.

11. The system of claim 10, wherein automatically performing an order transaction comprises automatically transmitting an order for a number of beverages to a beverage provider and automatically transmitting a pre-specified monetary amount to the first venue.

12. The system of claim 10, wherein the plurality of user interfaces includes one or more of: a supplier user interface, a distributor user interface, wholesaler user interface, an off-premise retailer user interface, a regulatory authority user interface, a venue user interface, a platform provider user interface, and a consumer user interface.

13. A system for product distribution and analysis comprising:
a plurality of mobile user device including user interfaces;
at least one hardware processor in communication with the plurality of mobile user devices; and
one or more software modules configured to, when executed by the at least one hardware processor:
identify a location of each of the plurality of mobile user devices;
determine that a user of a first user device of the plurality of mobile user devices meets one or more offer redemption conditions;
display a plurality of consumer offers based on the location of the first user device;
receive a selection of one consumer offer of the plurality of consumer offers; and
enable a user of the first user device to redeem the one consumer offer at a venue.

14. The system of claim 13, wherein the one or more software modules are further configured to, when executed by the at least one hardware processor: based on the selection of the one consumer offer, enable the user to navigate to a venue associated with the one consumer offer; determine that the user has arrived at the venue; and based on the determination, trigger the enabling of the user to redeem the one consumer offer.

15. The system of claim 13, wherein enabling the user to redeem the one consumer offer comprises setting a countdown timer on the one consumer offer and displaying the countdown timer via the user interface.

16. The system of claim 13, wherein enabling the user to redeem the one consumer offer does not include any wired or wireless communication between the mobile user device and a device of the venue.

17. The system of claim 13, wherein the one or more software modules are further configured, when executed by the at least one hardware processor, to: enable the user of the first user device to, after redeeming the offer, provide feedback on the offer.

18. The system of claim 13, wherein the one or more software modules are further configured, when executed by the at least one hardware processor, to: enable each user of the plurality of mobile user devices to redeem and provide feedback on multiple consumer offers.

19. The system of claim 18, wherein the one or more software modules are further configured, when executed by the at least one hardware processor, to: based at least on the feedback, generate one or more flavor profiles for each of the users of the plurality of mobile user devices.

20. The system of claim 13, wherein the one or more software modules are further configured, when executed by the at least one hardware processor, to: enable each user of the plurality of mobile user devices to provide secondary user information.

21. The system of claim 20, wherein enabling each user of the plurality of mobile user device to provide secondary user information comprises providing a plurality of user inquiries to each user, wherein the plurality of user inquiries are distributed over a period of time.

22. The system of claim 21, wherein individual inquiries of the plurality of user inquiries are provided to an individual user as an addition to a consumer offer feedback request.
